(19) United States
(12) Patent Application Publication
(10) Pub. No.: US 2003/0221860 A1
(43) Pub. Date: Dec. 4, 2003

(54) Non-halogenated non-cross-linked axially arranged cable

(76) Inventors: Martin Jay Van Der Burgt, Richmond, IN (US); Lindsay Achamma Scites, Beavercreek, OH (US)

Correspondence Address: Box IP Department, Lewis, Rice & Fingersh, L.C., Suite 2000, 500 North Broadway, St. Louis, MO, 63102, US

(21) Appl. No.: 10/409,263

(22) Filed: Apr. 8, 2003

Related U.S. Application Data
(60) Provisional application No. 60/372,333, filed on Apr. 12, 2002.

(51) Int. Cl. H01B 7/00

(52) U.S. Cl. 174/110 F

(57) ABSTRACT

Axially arranged cable designs, such as coaxial and triaxial cable designs, utilizing non-halogenated and non-cross-linked construction materials (thermoplastics), particularly in a dielectric layer, and the methods of making the same.

### CROSS REFERENCE TO RELATED APPLICATIONS

This Application claims priority to U.S. Provisional Patent Application Serial No. 60/372,333 filed Apr. 12, 2002 the entire disclosure of which is herein incorporated by reference.

### BACKGROUND

1. Field of the Invention

This disclosure relates to the field of cables and, in particular, to electronic cable using non-halogenated, non-cross-linked materials.

2. Brief Description of the Related Art

Mankind is increasingly aware that the Earth is a limited resource and it is desirable to produce products that meet our requirements for performance, ease of use, and manufacturability while, at the same time, manufacturing these products without using substances that damage the Earth's atmosphere, land, or water. One class of dangerous substances which has recently attracted a lot of attention because of its environmental impact are the broad class of chemicals known as halogens.

Halogens are used in a wide variety of products in a plethora of industries. Further, many halogens are either used in, or produced by various other manufacturing processes to make other types of products. Some such products to use halogens are various types of cabling. In particular, halogens are used to manufacture products used to insulate many coaxial cables to provide for desired burn resistance, insulation, and other desirable properties. One type of cable utilizing halogens is the so-called RG-type RF coaxial cable which is essentially a de-facto standard in radio frequency communications applications. These RG-type cables routinely use fluorinated ethylene propylene (FEP), polytetrafluoroethylene (PTFE), and perfluoro-alkoxy (PFA). All of these materials are halogen bearing or “halogenated.”

While these materials provide excellent cable characteristics, such as a high thermal capacity and good signal propagation, the materials also have many dangerous side effects. In the first instance, the manufacture of halogenated products is potentially damaging to the environment as numerous hazardous chemicals may be created and used during their production. Secondly, in a fire, halogenated cables which are incinerated under incomplete combustion release hazardous acids and gases such as dioxins which pose a significant health and safety risk to persons in the burning structure or firefighters combating the blaze. Further, the discharged acids and gases can cause significant damage to electrical or electronic equipment. Even outside the danger of fire while the cables are in use, when halogenated cables are disposed of they are often incinerated which can lead to the release of the same gases creating a danger to sanitation or disposal workers, and releasing the dangerous chemicals into the atmosphere.

As the dangers and problems associated with halogenated cables have become more apparent, and as companies have become more environmentally aware, there have been attempts made to replace halogenated cables with non-halogenated products. In particular, cross-linked insulators (such as cross-linked polyethylene or other thermoset plastics) have been used. Cross-linking is generally a process of exposing a polymer to radiation and/or a catalyst within a particular environment which causes the polymer chains of the material to link together.

While cross-linked products have the benefits of not being halogenated, they still have other problems. In particular, the chemical and/or irradiation processes used to create cross-linked products are expensive and the cross-linking processes leave contaminants or impurities in the cable which increase the cables' resultant attenuation and decrease its performance. Further, the manufacturing process required by cross-linking can adversely affect cable properties. Halogenated products, however, are easily and consistently extruded using well-known techniques. Therefore, cross-linked products are generally technically inferior to the previously constructed halogenated products.

As electrical/electronic communication becomes a more prevalent part of society, better cable performance is being demanded for many applications. Therefore, products which are technically inferior may not be used, even if they are better for the environment. For this reason, there is a desire in the art to produce cables which are both non-halogenated and non-cross-linked as a direct substitute for halogenated cables. Preferably, these products are also easily and inexpensively manufactured.

### SUMMARY

Disclosed herein, among other things, are axially arranged cable designs, such as coaxial and triaxial cable designs, utilizing non-halogenated and non-cross-linked construction materials, particularly in a dielectric layer.

Particularly there is disclosed in an embodiment, a cable comprising: a conductor and a non-halogenated thermoplastic dielectric material, which may be extrudable and/or foamed.

In an embodiment, this cable can also comprise a shield and/or may be an axially arranged cable, such as but not limited to a coaxial cable which may be an RG-type cable. The dielectric material may also comprise foamed polypropylene.

In an embodiment this cable may further comprise a jacket which may be made of a flame-retardant polyolefin, a non-halogenated thermoplastic and/or thermoplastic vulcanizates (TPV).

In an embodiment the cable may be a substitute for at least one of: a PTFE RG-type cable, an FEP RG-type cable, and/or a PFA RG-type cable.

Also disclosed herein is an embodiment of a coaxial cable, which may be an RG-type cable, comprising: a center conductor having a longitudinal axis; a layer of foamed polypropylene surrounding the center conductor along the longitudinal axis; a shield surrounding the layer of foamed polypropylene along the longitudinal axis; and a flame-retardant polyolefin jacket surrounding the shield along the longitudinal axis.

Also disclosed herein is an embodiment of an axially arranged cable comprising: a center conductor comprising metal and having a longitudinal axis; a layer of a foamed thermoplastic surrounding the center conductor along the longitudinal axis; a shield comprising metal and surrounding the layer of foamed thermoplastic along the longitudinal axis; and a jacket comprising thermoplastic and surrounding the shield along the longitudinal axis.

In another embodiment, the foamed thermoplastic may comprise foamed polypropylene and/or the jacket may comprise a non-halogenated thermoplastic.

In still another embodiment, there is disclosed a cable comprising: a conductor and a non-halogenated thermoplastic dielectric material, which may be extrudable and/or foamed, wherein the cable has a thermal capacity of at least 100° C.

### BRIEF DESCRIPTION OF THE FIGURES

FIG. 1 provides a cross-sectional view of an embodiment of a coaxial cable including a non-halogenated thermoplastic dielectric.

FIG. 2 provides a cross-sectional view of an embodiment of a coaxial cable including a foam polypropylene dielectric material and a non-halogenated flame retardant polyolefin jacket. FIG. 2 is cross-hatched to show materials.

### DESCRIPTION OF PREFERRED EMBODIMENTS(S)

While the embodiments described herein relate specifically to coaxial cables, one of ordinary skill in the art would understand how the principles, methods and designs disclosed herein can be incorporated into other axially arranged cables such as, but not limited to, triaxial cables, twinaxial cables, and armored cables. In still further embodiments, the principles, methods, and designs could also be incorporated into other types of cable designs where a non-halogenated non-cross-linked and/or thermoplastic structure is desired.

While axially arranged cables are used in a wide variety of applications and in most of these applications it would be desirable to replace halogenated (those that include halogens in their structure or as part of their manufacture) and/or cross-linked (those that utilize procedures in their manufacture to cross-link polymer chains) axially arranged cables with non-halogenated non-cross-linked cables, this disclosure is going to focus on applications previously utilizing PTFE, FEP, or PFA containing RG-type coaxial cables. Common applications are therefore telecommunications systems and automotive applications, amongst other things. The principles discussed in conjunction with this particular cable could be readily adapted by one of ordinary skill in the art into other applications and/or other cables. Therefore, this disclosure should not be seen as limiting the disclosure to this preferred embodiment.

Generally, this disclosure will refer to non-cross-linked materials belonging to the class of materials known as thermoplastic plastics or more simply “thermoplastics.” Thermoplastics are generally plastics or other organic polymeric materials having linear or branched molecules and are therefore not cross-linked.

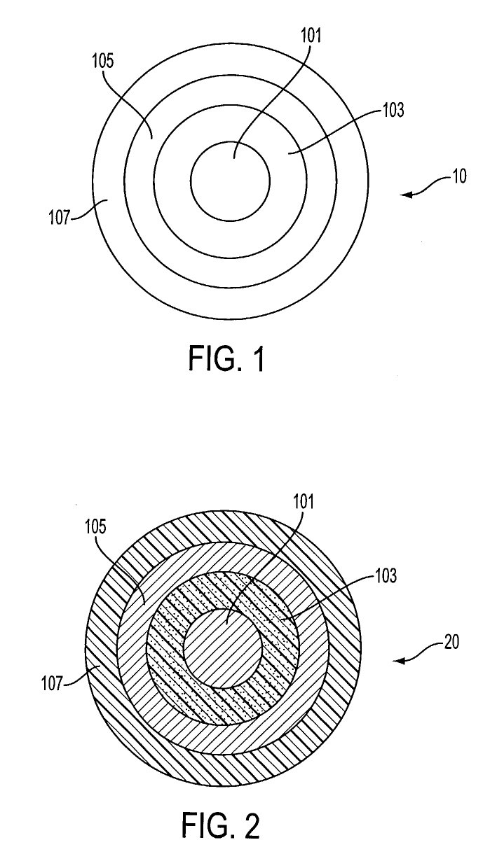

The embodiment provided in FIG. 1 shows a non-halogenated and non-cross-linked thermoplastic cable (10) suitable as a substitute to PTFE, FEP, or PFA RG-type coaxial cable. The embodiment provided in FIG. 2 provides for a specific cable (20) utilizing thermoplastic components. In the embodiments depicted in FIGS. 1 and 2, it is preferable, but by no means necessary, that the coaxial cables (10) and (20) have similar electrical properties to known PTFE/FEP/PFA RG-type halogenated coaxial cables. It is further preferable that the cables meet high-temperature operating requirements. It is therefore preferable that the thermal capacity of the material be at or above 100° C. for similar power and application temperature operation ranges.

FIGS. 1 and 2 show cross-sections of a coaxial cable (10) and (20), respectively, including a center conductor (101). Generally, center conductor (101) is a metallic conductive wire formed in any manner as would be known to one of ordinary skill in the art, such as but not limited to, wire drawing. (In FIG. 2 the center conductor (101) is a solid metallic conductor). In most cables, the center conductor (101) is a generally wire shape. That is, a flexible cylinder wherein the longitudinal axis of the cylinder is significantly larger than the diameter of the cylinder. Such a shape is, however, by no means required and the center conductor (101) could have any shape in cross-section or longitudinally. In yet another embodiment, the center conductor (101) may not be present at all, may be a braid or shield arranged around another dielectric material and/or insulator, or may comprise more than one conductor arranged jointly.

Surrounding the center conductor (101) along the length of the longitudinal axis is dielectric material (103) which is generally an insulating tube or layer. Dielectric material (103) in this embodiment generally comprises a non-halogenated thermoplastic material. In a preferred embodiment, this material will comprise a non-halogenated thermoplastic polyolefin dielectric. In a more preferred embodiment foam plastic such as foam polypropylene will be used as the non-halogen thermoplastic dielectric as shown in FIG. 2.

Foam polypropylene is the preferred material because it provides for similar propagation in the resulting cable to FEP, PTFE, or PFA cables, provides a suitably high temperature rating with a thermal capacity at or above 100° C., and is easily extruded without need for complicated and potentially dangerous techniques.

The dielectric material (103) is generally foamed as part of the extrusion process. In an embodiment, raw polypropylene pellets are melted into an extrudable form as is known to one of ordinary skill in the art. This liquid (which is under pressure) is then expanded with gas and is extruded in the standard fashion. As the pressure is released, the gas which is within expands leaving pockets, bubbles, or voids within the extruded material. One such product is manufactured by Polyone Synergistics.

The total void content of the dielectric material (103) will generally be chosen to meet the desired electrical property requirements of the resultant cable which, as discussed above, are preferably similar to known PTFE, FEP or PFA RG-type cable. The non-halogenated thermoplastic dielectric material (103) of FIGS. 1 and 2 generally requires no new or additional equipment to manufacture than what has been required to manufacture halogenated axially arranged cable which makes the process simpler and results in more consistent high-quality cable. The process is also generally safer than that for irradiated cross-linked polyethylene as no irradiating step is required. Finally, because the foaming step involves the introduction of minimal impurities, the resultant cables have improved electrical qualities over cross-linked designs.

Surrounding dielectric material (103) is another conductor generally referred to as a shield (105) which is generally metallic (as specifically shown in the embodiment of FIG. 2) and is designed to be electrically conductive. The shield (105) acts to electrically isolate the center conductor (101) from the external world helping to minimize stray electrical signals from being coupled into, or radiated from, a transmission line. The dielectric material (103) also helps to prevent any electrical contact between the shield (105) and the center conductor (101).

Generally, the shield (105) will be constructed through known techniques. In some cases, the shield will be constructed by applying a thin and narrow sheet of metal (a metal tape), which may or may not be laminated or otherwise attached on a substrate such as, but not limited to, plastic, to the exterior surface of the dielectric material (103) to surround the exterior surface of insulator (103) along the length of the longitudinal axis. In another type of cable, the shield (105) is generated from a plurality of wires or other conductive components which are woven or braided together about the dielectric material (103). In still other embodiments, shield (105) may comprise specific braided shields such as, but not limited to, a single braid, double braid, and/or “serve shield” as known to those of ordinary skill in the art, or a “French Braid” (double serve) as described in U.S. Pat. No. 5,303,630 to Gerald Lawrence, the entire disclosure of which is herein incorporated by reference. This braiding forms a tube of interlaced material which is electrically a single conductor and forms a shield (105). In still another embodiment, the two methods may be used in combination such as a metal tape being placed on the insulator (103) and then having a material braided thereon, vice-versa, or in multiple layers. In this case, the tape and braid together electrically form a single conductor and shield (105).

In the embodiment of FIGS. 1 and 2, after the shield (105) has been applied, the entire cable is then generally covered by a jacket (107) which is placed so as to surround the shield (105) and electrically isolates the shield (105) from other shields or conductors that are adjacent to the cable. This jacket (107) is generally insulative and also can be used to provide a printable surface for the placement of identifying indicia on the cable, to make the cable a particular color, or to improve the resultant appearance of the cable.

In an embodiment, jacket (107) will also be constructed of a non-halogenated thermoplastic material. In an embodiment, jacket (107) comprises a non-halogenated flame retardant material such as, but not limited to, a flame-retardant polyolefin as shown in FIG. 2 to provide both flame resistance and non-halogenated construction for the entire cable. In the embodiment of FIG. 2 the jacket may comprise non-halogenated thermoplastic vulcanizates (TPV). In particular, such a material can meet the minimum 100° C. thermal capacity desired without resort to halogenated or cross-linked materials. One polyolefin which meets the above requirements and may be used in jacket (107) is manufactured by Stenidy Industries and is identified as Thermagon™. In another embodiment, jacket (107) may be constructed of any type of material as would be known to one of ordinary skill in the art. In another embodiment, the material of jacket (107) may comprise dielectric material (103) and/or a foamed dielectric such as foamed polypropylene.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A cable comprising:
a conductor; and
a non-halogenated thermoplastic dielectric material;
wherein said cable has a thermal capacity of at least 100° C.

2. The cable of claim 1 further comprising a shield.

3. The cable of claim 2 wherein said cable is an axially arranged cable.

4. The cable of claim 3 wherein said cable is a coaxial cable.

5. The cable of claim 4 wherein said cable is an RG-type cable.

6. The cable of claim 1 wherein said dielectric material is extrudable.

7. The cable of claim 1 wherein said dielectric material is foamed.

8. The cable of claim 7 wherein such dielectric material comprises foamed polypropylene.

9. The cable of claim 1 further comprising a jacket.

10. The cable of claim 9 wherein said jacket is a polyolefin.

11. The cable of claim 9 wherein said jacket comprises a non-halogenated thermoplastic material.

12. The cable of claim 9 wherein said jacket comprises a non-halogenated thermoplastic vulcanizate (TPV).

13. The cable of claim 9 wherein said jacket comprises a flame-retardant material.

14. The cable of claim 1 wherein said cable is a substitute for at least one of: a PTFE RG-type cable, an FEP RG-type cable, and a PFA RG-type cable.

15. A coaxial cable comprising:
a center conductor having a longitudinal axis;
a layer of foamed polypropylene surrounding said center conductor along said longitudinal axis;
a shield surrounding said layer of foamed polypropylene along said longitudinal axis; and
a flame-retardant polyolefin jacket surrounding said shield along said longitudinal axis.

16. The cable of claim 15 wherein said cable is an RG-type cable.

17. An axially arranged cable comprising:
a conductor comprising metal and having a longitudinal axis;
a layer of a foamed thermoplastic surrounding said center conductor along said longitudinal axis;
a shield comprising metal and surrounding said layer of foamed thermoplastic along said longitudinal axis; and
a jacket comprising thermoplastic and surrounding said shield along said longitudinal axis.

18. The cable of claim 17 wherein said foamed thermoplastic comprises foamed polypropylene.

19. The cable of claim 17 wherein said jacket comprises polyolefin.

20. The cable of claim 17 wherein said jacket comprises a thermoplastic vulcanizate (TPV).
